(19) United States
(12) Patent Application Publication
(10) Pub. No.: US 2013/0148588 A1
(43) Pub. Date: Jun. 13, 2013

(54) SCHEDULER AND SCHEDULING METHOD FOR CARRIER AGGREGATED COMMUNICATIONS

(71) Applicants: Adrien Joseph COMEAU, Ottawa (CA); David Alan DONALD, Ottawa (CA); Gary David BOUDREAU, Kanata (CA)

(72) Inventors: Adrien Joseph COMEAU, Ottawa (CA); David Alan DONALD, Ottawa (CA); Gary David BOUDREAU, Kanata (CA)

(73) Assignee: TELEFONAKTIEBOLAGET LM ERICSSON, Stockholm (SE)

(21) Appl. No.: 13/323,352

(22) Filed: Dec. 12, 2011

(51) Int. Cl. H04W 72/12

(52) U.S. Cl. 370/329

(57) ABSTRACT

A method and system for allocating information flows of information to communication resources are disclosed. In one embodiment, separate flows of information in data received from a communication network are identified. Each separate information flow is associated with a component carrier for the duration of the information flow, and each component carrier is associated with a scheduler.

### TECHNICAL FIELD

The present invention relates to wireless communication, and in particular to a method and system for scheduling information flows.

### BACKGROUND

The long term evolution (LTE) air interface and LTE Advanced have features designed to increase peak bandwidth per user as compared with other air interface technologies. Carrier aggregation (CA) is one such feature defined for LTE Advanced. Carrier aggregation is a process where two to five component carriers (CCs) are aggregated and allocated to a user equipment (UE), e.g., a smart phone, in order to support transmission bandwidths up to 100 Mega-Hertz (MHz) per UE. A UE may simultaneously receive and transmit on multiple component carriers.

Referring now to the drawing figures, wherein like reference designators denote like elements, there is shown in FIG. 1 an example of a known communication system that utilizes carrier aggregation to allocate resources, the communication system denoted generally as “10”. Multiple information flows received from a network are identified by an information flow identification module 14 of a scheduler 16. Information flow, as used herein, refers to a stream of information that is associated with a particular source and destination, and may include voice, video, and text data. Each information flow is assigned by a Media Access Controller (MAC) 18 to a particular one of a plurality of radios 20a, 20b, and 20c, referred to collectively as radios 20.

Each radio includes a hybrid automated repeat request (HARQ) module 22 and a physical layer device 24. The HARQ module 22 adds error detection and correction information to a signal to be transmitted over an air interface to enable a receiving user equipment (UE) to detect and correct errors. The HARQ module 22 also determines whether a transmission of a transport block is to be repeated because it was not properly received by the UE. For example, if the receiver cannot correct errors in the transmission, the receiver will send a message back to a scheduler of the radio 20, which will attempt to retransmit the signal. Reaching a decision to retransmit is typically required to take less than one millisecond, and the time between transmissions of transport blocks is set by the LTE standard to be less than 4 milliseconds in frequency division duplex LTE systems.

The physical layer device 24 includes modulation, encoding, upconversion, and power amplification functionality to transmit a signal via an antenna (not shown). The physical layer device 24 may also perform time slot allocations to allocate different information flows to different time slots.

Note that the scheduler 16 may be in a central location that is remote from a location of the radios 20 and the radios 20 may be remote from each other. In such a configuration, a high speed link is required between the scheduler 16 and a radio 20 in order to handle the relatively high speed at which transmission of an information flow is assigned to different component carriers during the life of the information flow.

In the system of FIG. 1, a particular information flow may be carried by a first component carrier during a first interval of time and carried by a second component carrier during a second interval of time, etc., during the duration of the information flow. This is shown on the left hand side in FIG. 2. When the information flows are dynamically assigned to different component carriers during the life of the information flow, the link between the MAC 18 and the radios 20 must be a high speed link to schedule the transmission of transport blocks of data for each information flow at the rate that these transmissions should occur. The rate at which transmission of transport blocks occur is typically at least 1 transport block every 4 milliseconds. The requirement of a high speed link between the MAC 18 and the radios 20 disadvantageously limits the distance between the MAC 18 and the radios 20. Alternatively, the peak data rate requirement increases with increasing distance.

What is desired is an arrangement that eliminates the need for a high speed link between a scheduler and corresponding radios.

### SUMMARY

The present invention advantageously provides a method and system for allocating information flows to communication resources in a wireless communication system. According to one aspect, a wireless communication method includes segregating each of a plurality of received information flows. Each of the plurality of segregated received information flows are assigned to a different one of a plurality of schedulers for the duration of the information flow. Each scheduler is associated with a particular one of a plurality of component carriers. In some embodiments, an information flow is associated with a particular component carrier during an existence of the information flow.

According to another aspect, the invention provides a wireless communication system for allocating information flows to communication resources. The system has a first scheduler with an information flow identification processor and an assignment unit. The information flow identification processor separates data from a communication network into separate information flows of information. The assignment unit associates each information flow with a particular one of a plurality of component carriers for the duration of the information flow. In some embodiments, the wireless communication system also includes a plurality of second schedulers. Each second scheduler is associated with a corresponding one of the plurality of component carriers. Each second scheduler schedules transmission of transport blocks of data of an information flow on the corresponding component carrier.

According to another aspect, the invention provides a method of allocating resources to a plurality of information flows in a communication system. Separate information flows of information in data received from a communication network are identified. Each separate information flow is associated with a component carrier for the duration of the information flow, and each component carrier is associated with a scheduler.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a known wireless communication system;

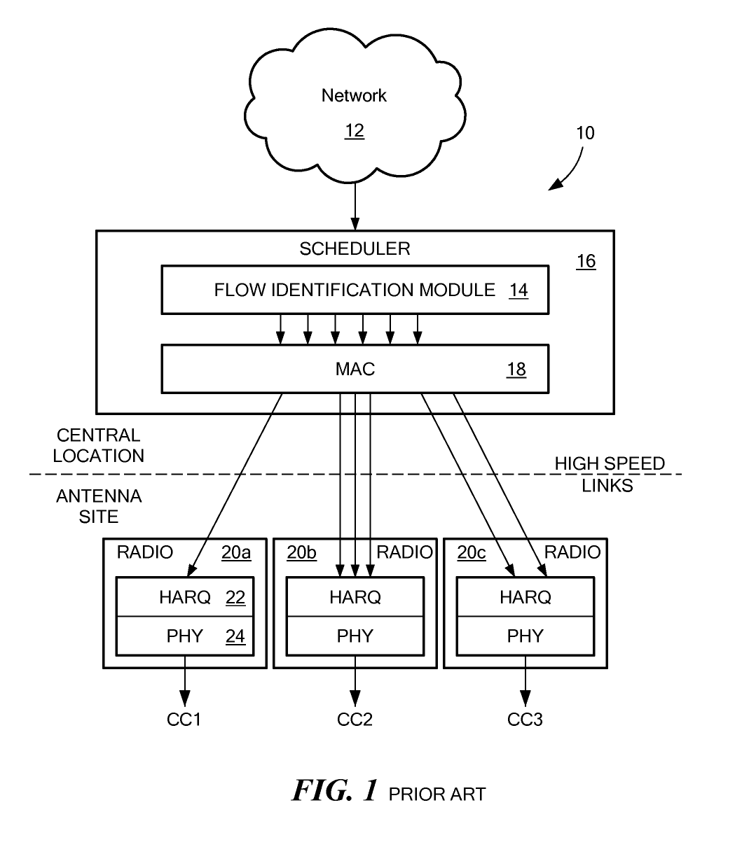

FIG. 2 is a diagram of two different assignment schemes for assigning information flows to component carriers;

FIG. 3 is a block diagram of an exemplary wireless communication system constructed in accordance with principles of the present invention;

FIG. 4 is a more detailed view of an exemplary wireless communication system constructed in accordance with principles of the present invention; and

FIG. 5 is a flowchart of an exemplary process for allocating resources in a wireless communication system according to principles of the present invention.

### DETAILED DESCRIPTION

Before describing in detail exemplary embodiments that are in accordance with the present invention, it is noted that the embodiments reside primarily in combinations of apparatus components and processing steps related to allocating information flows to communication resources in a wireless communication system. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

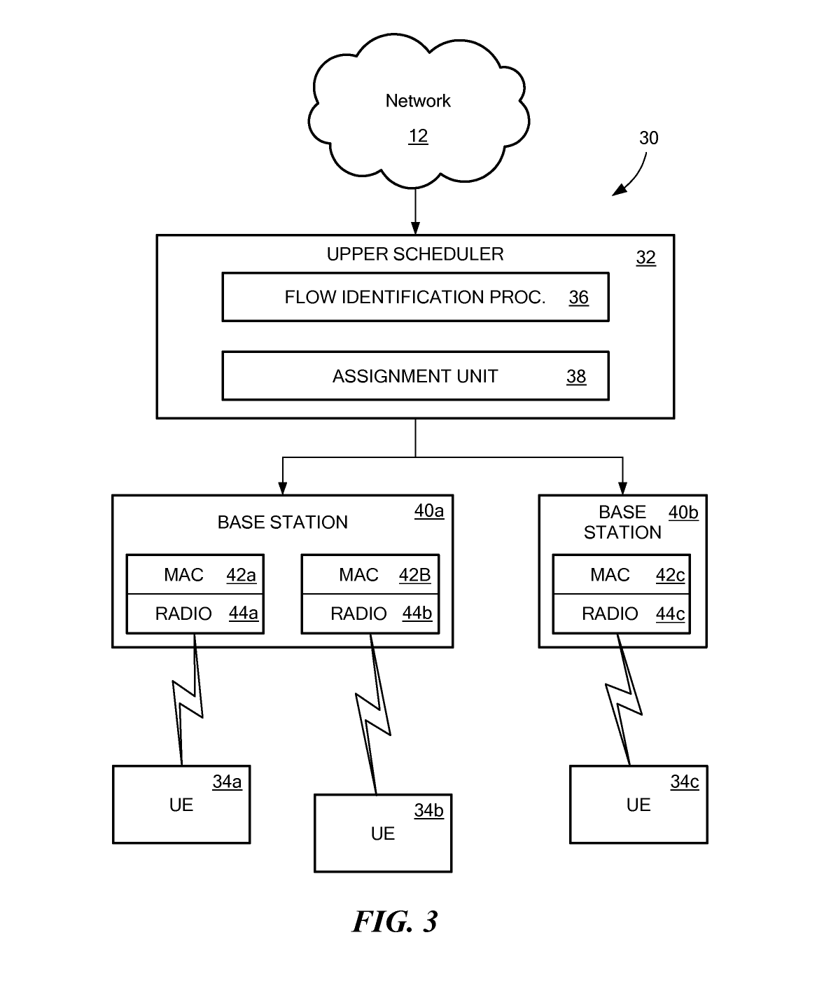

Referring again to the drawing figures, in which like reference designators denote like elements, there is shown in FIG. 3 a diagram of a wireless communication system constructed in accordance with principles of the present invention, generally denoted as system “30”. The system 30 includes a network 12 that may include, for example, the Public Switched Telephone Network (PSTN). Information is received by an upper scheduler 32 from the network 12 destined for a plurality of user equipment (UE) devices 34a, 34b, and 34c, referred to collectively herein as UE 34.

The information received from the network 12 may be segregated into individual information flows by an information flow identification processor 36. An information flow is a stream of information that is associated with a particular source and destination, and may include voice, video, and text data. Each information flow may be destined for a different UE 34 and/or multiple information flows may be destined for the same UE 34. The upper scheduler 32 presents a view of the information flows belonging to each UE 32 to an assignment unit 38. The upper scheduler 32 separates information flows for each target UE 34, detects start and termination of each information flow, and detects quality of service (QoS) information for each information flow. Note that the information flow identification process isolates information flows destined for UEs 34 that are not enabled for multiple carrier aggregation as well as for UEs 34 that are enabled for carrier aggregation.

The assignment unit 38 assigns each information flow to a different one multiple of component carriers transmitted by one or more base stations 40a and 40b, referred to collectively as base stations 40. The assignment of an information flow to a component carrier remains for the duration of the information flow. Thus, the assignment of information flows to component carriers is at a relatively slow rate because the rate is a rate at which the information flows come into existence. The assignment unit 38 assigns information flows to component carriers based on a set of rules that may seek to achieve fairness of allocation of communication resources.

Each base station 40 may have a buffer (not shown) for each component carrier assigned to a radio to buffer the received information flows. A buffer may be used due to a delay in transmission of a transport block of a particular information flow. Each base station has one or more lower schedulers or Media Access Controllers (MAC), 42a, 42b, and 42c, referred to collectively herein as lower schedulers 42 and one or more radios 44a, 44b, and 44c, referred to collectively herein as radios 44. Each lower scheduler 42 may be associated with a different one of the component carriers to which an information flow is assigned by the assignment unit 38. Note that a component carrier MAC 42 must allocate its spectrum between carrier-aggregation-enabled UEs and non-carrier-aggregation-enabled UEs. This allocation is communicated from the lower scheduler 42 to the upper scheduler 32 to enable the upper scheduler 32 to isolate information flows for the non-carrier aggregation-enabled UEs as well as the carrier aggregation-enabled UEs.

A MAC scheduler 42 operates at a relatively high speed as compared with assignment unit 38 to make scheduling decisions for each one of a plurality of transport blocks of an information flow to be transmitted. In some embodiments, a scheduling decision occurs at least once every 4 milliseconds. By moving the scheduling of transport blocks to the radio, as opposed to being located in the upper scheduler, relatively low speed links between the upper scheduler 32 and the base stations 40 may be employed, rather than high speed links, to transmit the information in each information flow from the upper scheduler 32 to the base stations 40.

Thus, one embodiment is a wireless communication method that includes segregating each of plurality of information flows received from a communication network, and assigning each information flow to a different one of a plurality of schedulers for the existence of the information flow. Each scheduler may be associated with more than one component carrier. And a component carrier may be assigned to more than one information flow via time division multiplexing (TDM). Further, in addition to segregating each information flow based on a source and destination of the information, an information flow may be further segregated based on a quality of service (QoS) associated with the information flow. The QoS may be associated with the information flow pursuant to a service level agreement (SLA).

The wireless communication methods described herein may be implemented in a long term evolution (LTE) network or other wireless communication network. Employing the methods described herein, information flows may be assigned to schedulers at a rate that is substantially slower than a decision rate at which a scheduler schedules transports blocks of information flows for transmission.

Note also that the geographic coverage of each component carrier may be different. Therefore, the upper scheduler 32 may take geographic coverage into account when assigning a particular information flow to a component carrier. Further, the upper scheduler 32 may determine, based on UE capability, if cells other than a current servicing cell can communicate with the UE. If carrier aggregation is enabled for a particular UE, selection of a servicing cell may be based on a desire to evenly balance the loads of each cell, or may be based on a desire to preserve larger cells for UEs outside the coverage area of a smaller cell. Further, the upper scheduler may occasionally “repack” selected users into cells with a smaller coverage ranking to enable extending fair access of other selected users to component carriers having a larger coverage ranking.

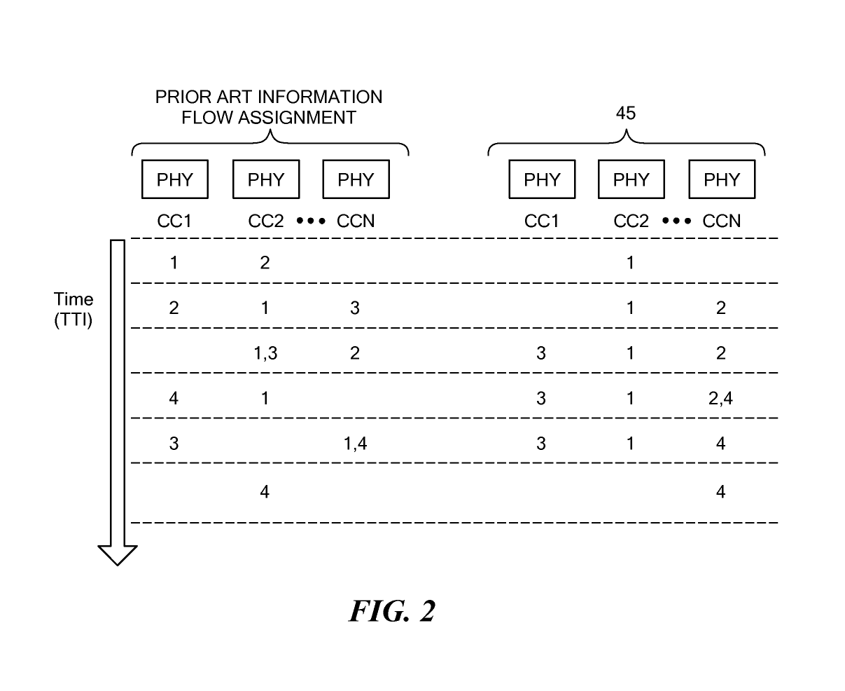

The right hand side 45 of FIG. 2 depicts an example of information flow assignments to component carriers according to principles of the present invention. Each information flow is assigned to a different component carrier (CC) and remains assigned to the component carrier for the entire duration of the information flow, with the exception of handoffs. In contrast to the prior art left hand side of FIG. 2, which shows information flows being assigned to multiple different carriers during the life of an information flow, the right hand side 45 of FIG. 2 shows each information flow being assigned to one and only one carrier during the life of the information flow. This enables the use of low speed links between the upper scheduler 32 and the base stations 40. Use of low speed links enables larger distances between a location of the upper scheduler 32 and the locations of the base stations 40. Thus, embodiments allow the latency of a link to be larger than would be the case without implementation of the embodiments described herein. A link's latency is proportional to the length of the link and inversely proportional to the bandwidth of the link. Since embodiments described herein allow for higher link latencies, a reduction in bandwidth for a given link length is allowable. Alternatively, for a given bandwidth, the link length can be longer.

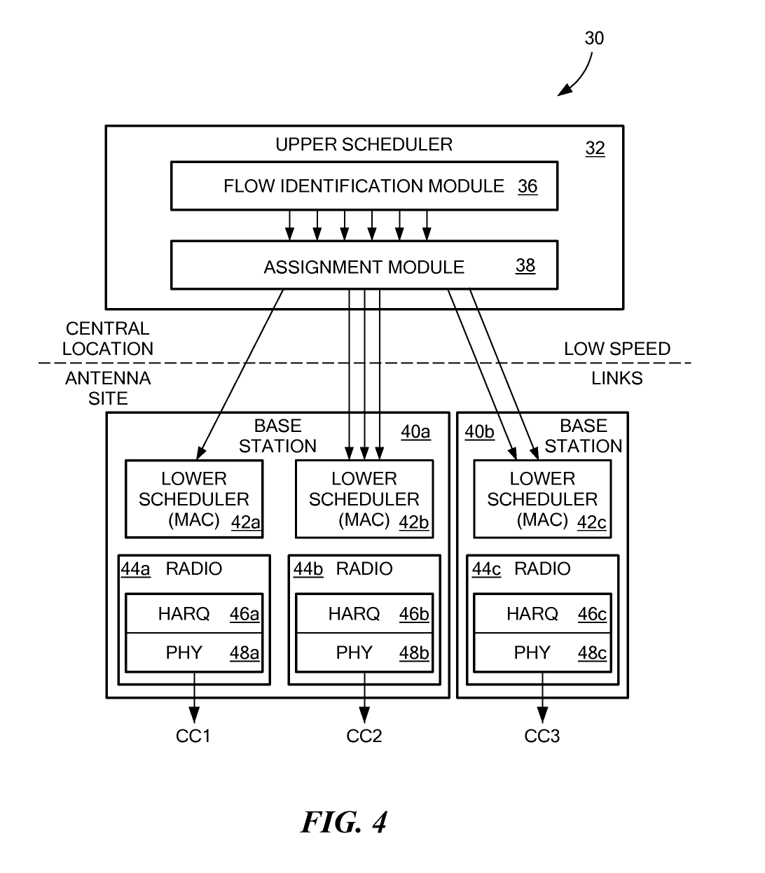

FIG. 4 is a more detailed view of a wireless communication system 30 constructed in accordance with the present invention. The upper scheduler 32 may be located in a central location remote from the plurality of base stations 40. Also, in some embodiments, the base stations 40 may be located remote from their antennas. The information flow identification processor 36 segregates each of a plurality of received information flows. Each information flow may be segregated based on its origin and destination. Each information flow may contain data, video, text and/or audio content.

The assignment module 38 assigns each of the plurality of received information flows to a different one of a plurality of lower schedulers (MAC) 42. As such, the assignment module 38 may perform multiplexing of the information flows to the different lower schedulers 42. Each lower scheduler 42 is associated with a particular one of a plurality of component carriers for the duration of the information flow. The assignments may be based on a load associated with a lower scheduler 42. Also, the assignments may be based on a fairness algorithm, which gives each information flow fair access to transmission resources of the wireless communication system 30. Note that a single lower scheduler may assign more than one information flow to a particular component carrier, wherein each information flow is assigned to different time slots. Thus, using time division multiplexing, multiple component carriers may be implemented by a single MAC (scheduler) 42 and radio 44, and a single component carrier may be assigned to multiple information flows. However, as shown in the right hand side 45 of FIG. 2, a single information flow may be assigned to one and only one component carrier during the existence of the information flow.

Each scheduler 42 schedules transmission of transport blocks of data of an information flow on a particular component carrier to which the information flow is assigned. The lower scheduler 42 may make scheduling decisions at least once every millisecond, and may facilitate transmission of each transport block at a rate of at least one every four milliseconds. By assigning a separate component carrier to an information flow, the relatively high speed of scheduling transport blocks may be performed without requiring a high speed link from the upper scheduler 32 to each base station 40. Rather, assignment of information flows to component carriers occurs at the much slower rate at which information flows come into existence, and therefore a low speed link from the upper scheduler to each base station will suffice.

The radios 44 connected to lower schedulers 42 include HARQ units 46a, 46b, and 46c, referred to collectively herein as HARQ units 46, and physical layer units 48a, 48b, and 48c, referred to collectively herein as physical layer units 48. A HARQ unit 46 performs conventional hybrid automated repeat request functions. For example, the HARQ unit 46 may cause repeated transmission attempts until a user equipment (UE) indicates in a reply message that a transport block has been correctly received. A decision whether to retransmit a transport block may be required at least once every millisecond and a transport block may be required to be transmitted at least once every four milliseconds, according to some wireless communication standards, including frequency division duplex implementations of the long term evolution (LTE) standard.

The physical layer unit 48 performs conventional radio functions for transmission of transport blocks via a component carrier. For example, the physical layer unit 48 may perform modulation, encoding, up-conversion and power amplification of signals to be transmitted by the radio 44. In some embodiments, the physical layer unit may allocate different information flows to different time slots. For example, a first information flow may be assigned to a first time slot and a second information flow may be assigned to a second time slot, with both the first and second time slot being supported by the same component carrier.

Thus, one embodiment is a wireless communication system having a first scheduler 32 that identifies and assigns a different flow of information to a different component carrier for the duration of an information flow. This may be done according to a fairness algorithm. The wireless communication system may further include a plurality of lower schedulers 42 associated with different corresponding ones of the component carriers. Each lower scheduler 42 schedules transmission of transport blocks of data of an information flow on its corresponding component carrier at a rate that is substantially faster than a rate at which information flows are assigned to a component carrier. Further, a lower scheduler 42 may schedule transport blocks of an information flow based on channel conditions.

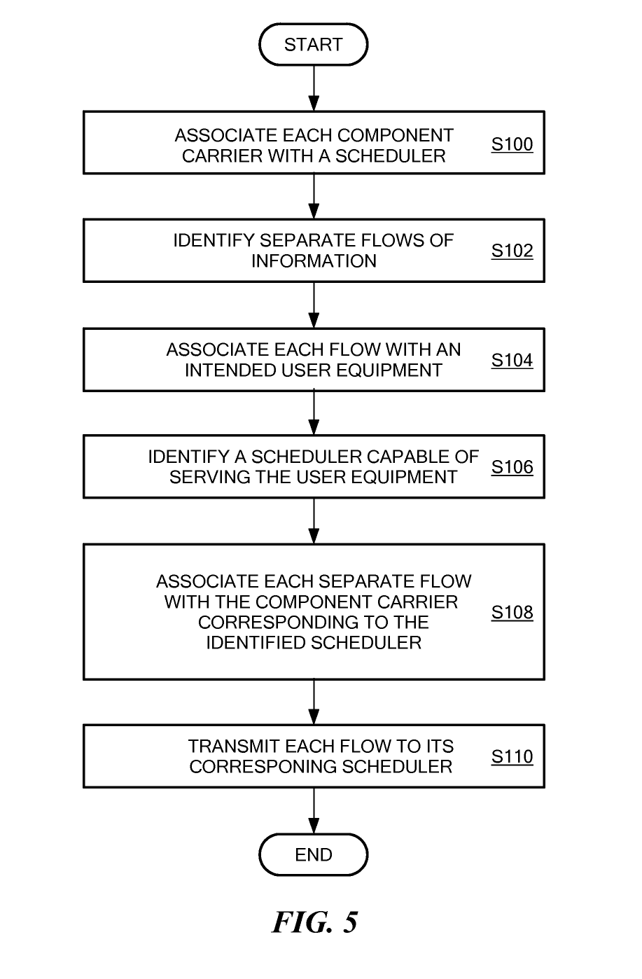

FIG. 5 is a flow chart of an exemplary process for allocating resources in a wireless communication system according to principles of the present invention. Each component carrier is associated with a different scheduler (step S100). Separate information flows of information received from a network are identified and separated (step S102). Each information flow may be associated with a different user equipment (step S104). A scheduler is identified that is capable of serving the user equipment (step S106). An information flow intended for a particular user equipment is associated with a component carrier (step S108) for the duration of the information flow, and the information flow is assigned to a scheduler corresponding to the component carrier (step S110).

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A wireless communication method, comprising:
segregating each of a plurality of received information flows; and
assigning each of the plurality of segregated received information flows to a different one of a plurality of schedulers for the duration of the information flow, each scheduler associated with a particular one of a plurality of component carriers.

2. The method of claim 1, wherein each scheduler may be associated with more than one component carrier.

3. The method of claim 1, wherein an information flow is segregated based on a quality of service (QOS).

4. The method of claim 1, wherein the component carriers are carriers in a long term evolution (LTE) wireless communication system.

5. The method of claim 1, wherein the assigning is based on a load associated with each scheduler.

6. The method of claim 1, wherein the assigning is performed at a first location remote from locations of the plurality of schedulers.

7. The method of claim 1, further comprising assigning the information flows to the schedulers at a rate that is substantially slower than a decision rate at which a scheduler schedules transport blocks of information flows for transmission.

8. A wireless communication system, comprising:
a first scheduler having:
an information flow identification processor, the information flow identification processor separating data from a communication network into separate flows of information;
an assignment unit, the assignment unit associating each separated information flow with a particular one of a plurality of component carriers for the duration of the information flow.

9. The wireless communication system of claim 8, wherein the assignment unit is configured to allocate information flows to component carriers according to a fairness algorithm.

10. The wireless communication system of claim 8, further comprising a plurality of second schedulers, each second scheduler associated with a corresponding one of the plurality of component carriers, each second scheduler scheduling transmission of transport blocks of data of an information flow on the corresponding component carrier.

11. The wireless communication system of claim 10, wherein the scheduled transmissions are scheduled so that transport blocks are transmitted at a rate of at least one transport block every 4 milliseconds.

12. The wireless communication system of claim 8, further comprising a multiplexer to transmit each different information flow to a separate one of a plurality of schedulers.

13. The wireless communication system of claim 8, wherein the assignment unit associates each information flow with a component carrier at a rate at which information flows are created.

14. The wireless communication system of claim 8, further comprising at least one RF device having an RF radio, each of the at least one RF devices being associated with a different component carrier.

15. The wireless communication system of claim 8, wherein the rate of association of each information flow with a particular one of the plurality of component carriers by the assignment unit of the first scheduler is substantially lower than a rate of scheduling transmission of transport blocks of data of an information flow on a particular component carrier.

16. A method of allocating resources to a plurality of information flows in a wireless communication system, the method comprising:
identifying separate flows of information in data received from a communication network;
associating each information flow with a component carrier for the duration of the information flow; and
associating each component carrier with a scheduler.

17. The method of claim 16, further comprising transmitting each information flow to a scheduler associated with the component carrier that is associated with the corresponding information flow.

18. The method of claim 16, wherein an association of an information flow with a component carrier is terminated when an information flow terminates.

19. The method of claim 18, wherein each information flow is further associated with a particular user equipment and wherein the information flow associated with a particular user equipment is further associated with a scheduler that serves the particular user equipment for the duration of the information flow.

20. The method of claim 19, wherein transport blocks of an information flow are scheduled for transmission according to a scheduling algorithm that depends on channel quality.
